(19) United States
(12) Patent Application Publication
(10) Pub. No.: US 2006/0287819 A1
(43) Pub. Date: Dec. 21, 2006

(54) Navigation system with intersection and three-dimensional landmark view

(76) Inventors: Christian Brulle-Drews, Hamburg (DE); Volker Grabs, Hamburg (DE)

Correspondence Address: BRINKS HOFER GILSON & LIONE, P.O. BOX 10395, CHICAGO, IL, 60610, US

(21) Appl. No.: 11/335,912

(22) Filed: Aug. 28, 2006

(30) Foreign Application Priority Data
Jan. 18, 2005 (EP) EP 05000944.8

(51) Int. Cl. G01C 21/00

(52) U.S. Cl. 701/211; 701/207; 340/995.24

(57) ABSTRACT

A vehicle navigation system helps guide a driver to a destination by enhancing visualization of landmarks and upcoming intersections. The navigation system stores resolution independent representations of the landmarks and intersections. The representations allow the navigation system to quickly and efficiently resize and render the landmarks and intersections without distortion and with reduced computational burden. When the vehicle approaches a landmark or intersection, the navigation system may retrieve the representation, mathematically scale the representation, adjust the perspective of the representation, and render a view of the upcoming landmarks and intersection to aid the driver with reaching the destination.

### BACKGROUND OF THE INVENTION

1. Priority Claim.

This application claims the benefit of priority from European Application No. 05000944.8, filed Jan. 18, 2005 which is incorporated by reference herein. This application is also related to U.S. patent application Ser. No. ______, filed on Jan. 18, 2006 entitled “Navigation System with Animated Intersection View,” and having attorney reference number 11336-1256, which is incorporated by reference herein in its entirety.

2. Technical Field.

This invention relates to route guidance provided by a vehicle navigation system. In particular, the invention relates to route guidance by displaying three-dimensional perspective views of landmarks and intersections to a driver.

3. Related Art.

Vehicle navigation systems analyze location and motion data provided by the Global Positioning System (GPS), motion sensors such as automatic braking system (ABS) wheel sensors, and digital maps to determine the position and velocity of a vehicle. Navigation systems generate digital maps to represent cartographic features, such as streets, buildings and rivers, and may obtain the cartographic feature data from a compact disc (CD), digital versatile disc (DVD), or other memory. After the navigation system generates the digital map, the navigation system provides an indicator of the actual position of the vehicle on the digital map. The navigation system provides acoustic and/or visual information to guide the driver to a predetermined destination.

Some navigation systems display route information on the digital map, as well as the maneuvers (e.g., turns or merges) needed at intersections to reach a destination. As the vehicle changes position, either the vehicle position mark on the displayed image changes, or the digital map may be scrolled, while the vehicle position mark remains fixed at a predetermined position. The navigation system may also display points of interest such as gas stations, restaurants, landmarks, or other points of interest. Bitmap images may be used to display the points of interest.

All navigation systems have upper limits on memory and processor performance. The limitations can be significant when the navigation system tries to render all of the navigation information which a driver may find useful on a display. In particular, bitmap images often include significant amounts of image data which the processor must retrieve and manipulate for display. Furthermore, in some cases, bitmap images may not deliver the desired image quality.

Therefore, a need exists for a navigation system to provide landmark and intersection views to a driver at a reduced computational cost, as well as to improve image quality.

### SUMMARY

A vehicle navigation system helps guide a driver to a destination by enhancing the visualization of upcoming landmarks and intersections. The navigation system stores scalable and compact vector graphics representations of landmarks and intersections. The vector graphics representations may be derived from digital image captures of landmarks or other geographical features. The vector graphics representations may be used to render perspective views of landmarks and intersections to provide a realistic display of the intersection and landmarks for the driver as the driver approaches an intersection, with reduced computational overhead on the navigation system and enhanced image quality. The vector graphics representation thereby aids the driver with following a recommended navigation route to the destination.

The vehicle navigation system includes a location system which determines the position and speed of the vehicle, a map database containing data related to geographical and topographical information for intersections, roads, and curves along a route, a vector graphics database containing two- or three-dimensional vector graphics representations of landmarks and intersections along a route, and perspective calculation logic to render the representations of the landmarks and intersections based on the vector graphics representations.

Other systems, methods, features and advantages of the invention will be, or will become, apparent to one with skill in the art upon examination of the following figures and detailed description. It is intended that all such additional systems, methods, features and advantages be included within this description, be within the scope of the invention, and be protected by the following claims.

### BRIEF DESCRIPTION OF THE DRAWINGS

The invention can be better understood with reference to the following drawings and description. The components in the figures are not necessarily to scale, emphasis instead being placed upon illustrating the principles of the invention. Moreover, in the figures, like referenced numerals designate corresponding parts throughout the different views.

FIG. 1 illustrates a comparison of a vector graphic and a digital picture of a landmark.

FIG. 2 shows a flow diagram of acts a navigation system may take to display landmarks.

FIG. 3 illustrates a flow diagram of acts a navigation system may take to display intersections and landmarks.

FIG. 4 illustrates an example of an intersection view.

FIG. 5 illustrates a vehicle navigation system.

FIG. 6 illustrates a second vehicle navigation system.

### DETAILED DESCRIPTION OF THE PREFERRED EMBODIMENTS

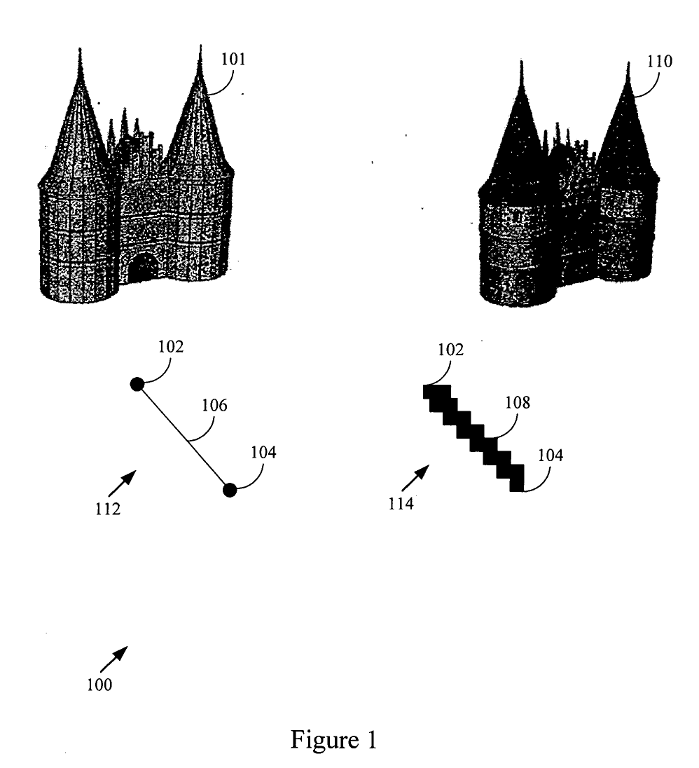

FIG. 1 illustrates an example vector graphic 101 obtained from a digital picture 110 taken with a camera. Digital images of points of interest may be recorded by video cameras, photo cameras, digital cameras, cellular telephone cameras, or other imaging devices. The digital images of the points of interest may be converted to a vector graphics representation and stored in a map database in the navigation system. The navigation system may then display the vector graphics representation of the points of interest on the digital map generated by the navigation system. The points of interest may include town landmarks, prominent buildings, distinctive geographical features, gas stations, museums, parks, restaurants, intersections, or any other points of interest.

The navigation system may synthesize three-dimensional models for display on the digital map using vector graphics representations of the points of interest and/or intersections. A vector graphics representation of a point of interest may include mathematical formulas, command sequences, points, lines, polylines, polygons, circles, ellipses, curves (e.g., Bezier curves) between the points, and other primitive objects which define the shape of the point of interest. The shapes may be filled with colors, blends, or textures. The vector graphics representation is resolution independent. In other words, the navigation system may resize the representation of any given point of interest by applying mathematical transformations to the components of the representation prior to display without loss of resolution.

In FIG. 1, the vector graphics representation 112 specifies two individual points (the points 102 and 104) and a curve (the line 106) to be drawn between the points 102 and 104. The vector graphics representation may be resized without artifacts, and may specify relatively few data points to define the shape of a point of interest, particularly compared to a bitmap image. In contrast, the bitmap image 114 of the line 108 includes many discrete pixels which render the line between the points 116 and 118. The vector graphics representation thereby leads to efficient storage for a graphical representation of a point of interest. In addition, the vector graphics representation provides the ability to resize the representation for displaying a view of the point of interest at any desired size on the digital map without distortion. The vector graphics representation assists the driver with recognizing both landmarks and intersections in addition to, or as an alternative to, bitmap representations of the landmarks and intersections.

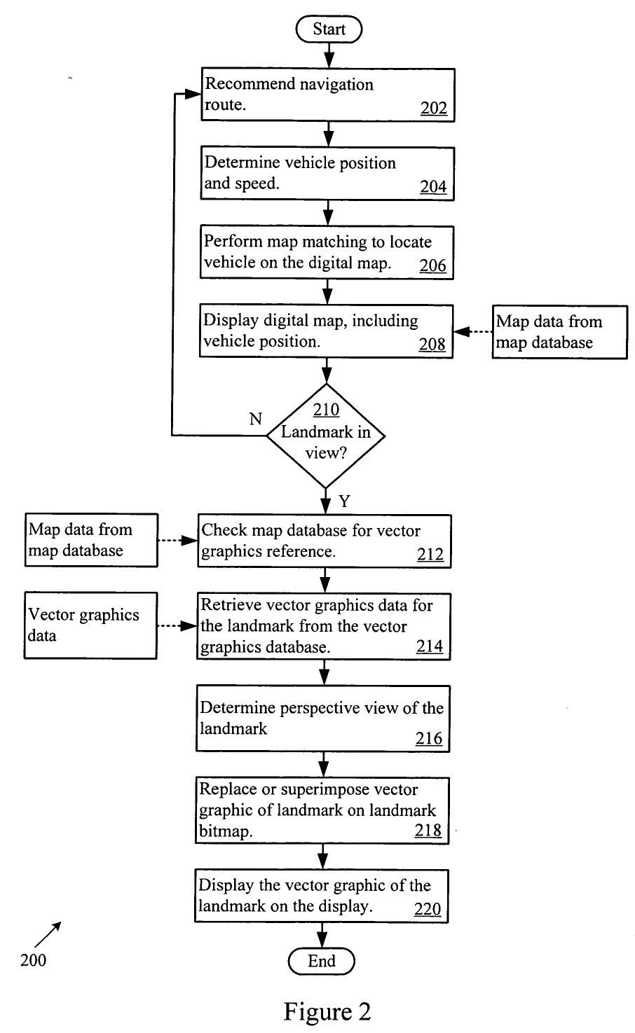

FIG. 2 illustrates acts 200 which a navigation system may take to display an intersection view using a vector graphics representation. The navigation system recommends a navigation route (Act 202). The navigation system may determine the position of the vehicle using data received by a GPS receiver, motion sensors, or other sensors (Act 204). Map matching may locate the vehicle with respect to a digital map stored in a map database (Act 206). The navigation system displays the digital map, including the vehicle position (Act 208). Based on the information about the actual position of the vehicle and the driving direction for the recommended route, the navigation system may determine the geographical section in view of the driver. The navigation system may determine, based on the vehicle position, geographical section, the map matching, and/or input from the map database whether a landmark comes into view (Act 210). For example, the landmark may come into view in the forward path of the vehicle along the recommended route. If no landmark is detected, the navigation system may continue to provide route recommendations, determine the vehicle position and speed, and update the digital map.

If a landmark is detected, the navigation system may check a map database to determine whether a database reference exists to a vector graphics representation for the landmark (Act 212). If the vector graphics representation is available, the navigation system retrieves the vector graphics representation for the landmark from a vector graphics database (Act 214). Alternatively, the navigation system may search the vector graphics database for the vector graphics representation instead of following a database reference from the map database.

A perspective view of the landmark may be determined for three-dimensional vector graphics representations (Act 216). The vector graphic representation, rotated, scaled, and/or adjusted according to the desired perspective, may replace, or may be superimposed on a bitmap representation of the landmark by a display controller (Act 218) to provide a view of the landmark. The landmark view, including the bitmap representation and/or vector graphics representation, may be shown on a display (Act 220). The display may be a cathode ray tube (CRT) display, liquid crystal display (LCD) display, plasma, organic lighted electric diode (OLED) display, thin film transistor (TFT) display, digital light projection (DLP) display, or other display.

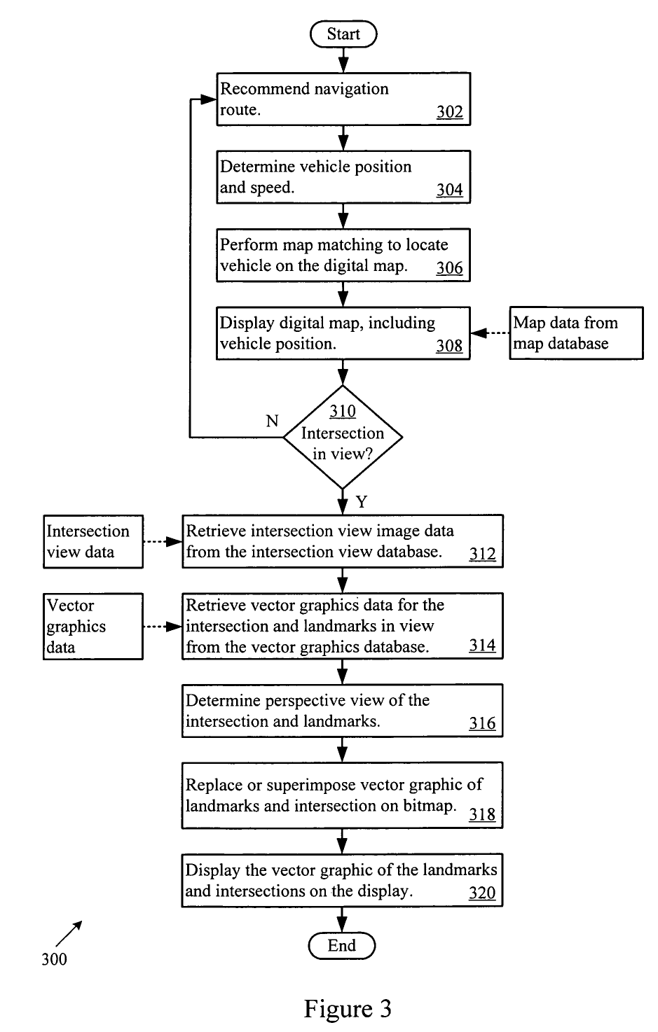

FIG. 3 illustrates a second example of the acts 300 that the navigation system may take for displaying an intersection view. The navigation system recommends a navigation route (Act 302). The navigation system may determine the position of the vehicle using data received by a GPS receiver, motion sensors, or other sensors (Act 304). Map matching may locate the vehicle with respect to a digital map stored in a map database (Act 306). The navigation system displays the digital map, including the vehicle position (Act 308). Based on the information about the actual position of the vehicle and the driving direction for the recommended route, the geographical section in view of the driver may be calculated. The navigation system may determine, based on the vehicle position, geographical section, the map matching, and/or input from the map database whether an intersection comes into view (Act 310). For example, the intersection may come into view in the forward path of the vehicle along the recommended route. If no intersection is detected, the navigation system may continue to provide route recommendations, determine the vehicle position and speed, and update the digital map.

If an intersection is detected, the navigation system may check a map database to determine whether a database reference exists to a vector graphic representation for the intersection in a vector graphics database (Act 312). If the vector graphics representation is available, the navigation system retrieves the vector graphics representation for the intersection (and nearby landmarks) from the vector graphics database (Act 314). Alternatively, the navigation system may search the vector graphics database for the vector graphics representation instead of following a reference from the map database. In addition, an intersection view database may store additional intersection view data (e.g., bitmap data), representing such features as the road geometry and the number of lanes. The intersection view data may also represent signposts or other text such as street names or house numbers, geographical features, or other geographical information. The intersection view data also may represent a sky and a skyline with the color of the sky adapted to the local time (which may be provided by the navigation system).

A perspective view of the landmarks and/or intersection may be calculated for three-dimensional vector graphics representations (Act 316). The vector graphic representation, rotated, scaled, and/or adjusted according to the perspective view, may replace, or may be superimposed on a bitmap representation of the landmark and intersection by a display controller (Act 318). The bitmap representation and/or vector graphics representation of the landmarks and intersections may be shown on a display (Act 220). The display may be a cathode ray tube (CRT) display, liquid crystal display (LCD) display, plasma, organic lighted electric diode (OLED) display, thin film transistor (TFT) display, digital light projection (DLP) display, or other display.

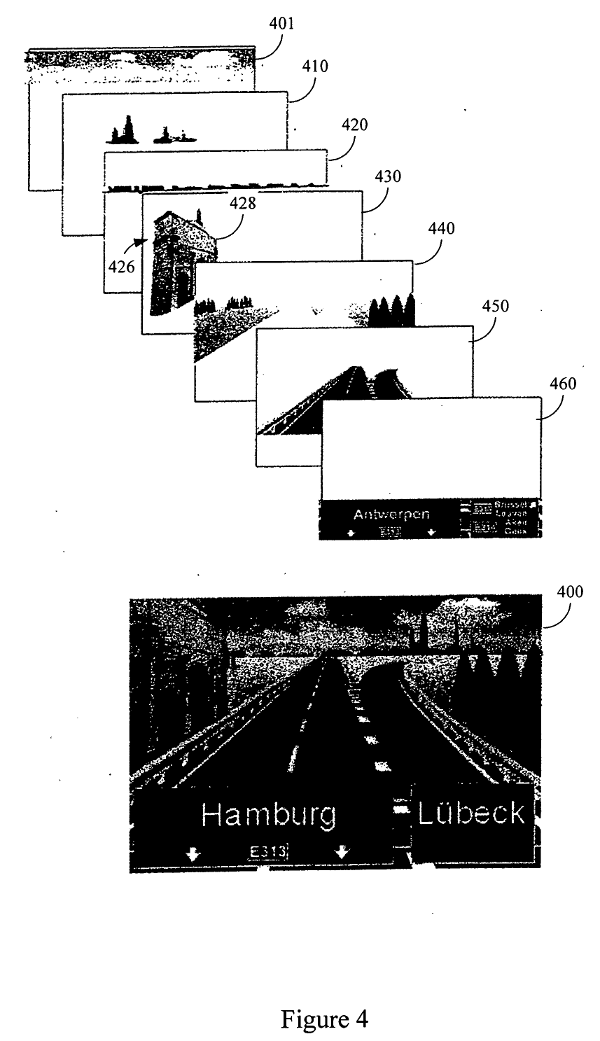

FIG. 4 illustrates an example composite navigation image 400, in this case an intersection view, synthesized from multiple display layers. Each layer may include bitmap image data, vector graphics image data, or both. The background display layer 401 shows a bitmap representing the sky. Landmarks in a three-dimensional vector graphics representation are displayed in a landmark display layer 410 rendered in front of the background layer 401. The next display layer 420 shows a bitmap representation of the skyline. Next, a second landmark layer 430 displays a local landmark in a perspective three-dimensional view calculated from a vector graphics representation of a landmark. Additional display layers 440, 450, and 460 show bitmaps representing a foreground image (e.g., the sides of the road), the road geometry, and signposts. The display layers 401, 410, 420, 430, 440, 450, and 460 may be displayed and updated at specific time intervals or distances, continuously, in response to specific events (e.g., approaching within a threshold distance of a landmark), or at other times.

The composite navigation image 400 displays vector graphics derived images in the landmark display layer 410 and 430. As the vehicle moves, the navigation system may scale, rotate, or otherwise transform the images quickly and efficiently based on the relatively few primitives defining the representations, and without loss of resolution. As a result, the navigation system may spend less computational resources to deliver the image to the driver, yet consistently update the images to provide a more responsive, accurate, and user friendly display of landmark and/or intersection views.

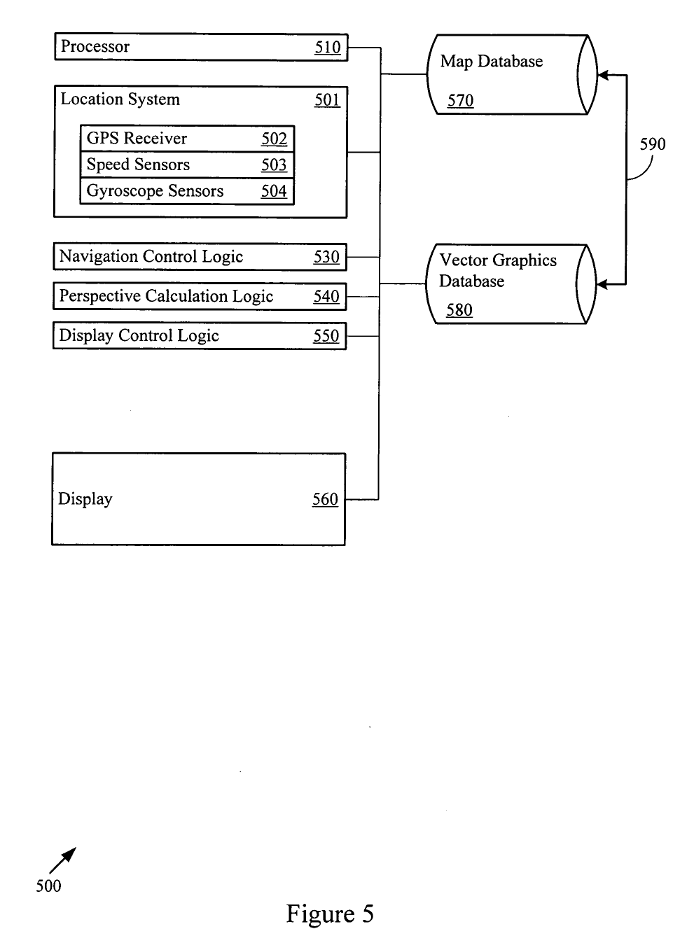

FIG. 5 illustrates a vehicle navigation system 500 that provides two- and three-dimensional vector graphics representations of landmarks and intersections. The vehicle navigation system 500 includes a location system 501, one or more processors 510, and navigation control logic 530. The navigation system 500 also includes perspective calculation logic 540, display control logic 550, and a display 560. A map database 570 and a vector graphics database 580 are also present.

The location system 501 may provide location data for a determination of the position of the vehicle. The location system 501 may include a GPS receiver 502 that receives radio waves transmitted from GPS satellites, a speed sensor 503, a gyroscope sensor 504, and/or other motion or location sensors. The speed sensors 503 may include ABS wheel sensors and may detect the distance traveled by the vehicle and/or the vehicle speed. The angular velocity of the vehicle may be measured by a gyroscope sensor 504. The gyroscope 504 may be a piezoelectric sensor with a detection crystal vibrating in one plane to measure rotation of the vehicle around an axis that is directed perpendicular to the road.

The navigation system 500 may implement filters, such as a Kalman filter, to help reduce operational errors in the sensor output, or to combine the sensor outputs to compensate for errors or improve measurement accuracy. The location system 501 may include other types of sensors, such as geomagnetic sensors or angle sensors that measure the steering angle of the vehicle. The navigation system 500 may employ map matching with the data provided by the location system and the map database 570, thereby locating the vehicle on the map.

The processor 510 processes the information provided by the location system 501 and the map database 570. The navigation control logic 530 may locate the vehicle with respect to the maps in the map database 570, may perform route planning, and may provide the driver with route directions. When more than one processor 510 is available, the processors may share memory which is locally or remotely interfaced with the processors. The memory may include non-volatile memory such as electrically erasable read-only memory (EEPROM), or Flash memory, volatile memory such as dynamic random access memory (DRAM), a hard disk, digital versatile discs (DVD), compact disc (CD), magneto-optical disks, or other types of memory.

The data in the map database 570 may include database references 590 to vector graphics representations in the vector graphics database 580. The processor 510 may follow the database reference 590 to the vector graphics database 580 to retrieve a vector graphics representation of a landmark or intersection from the vector graphics database 580. Alternatively, the processor 510 may search the vector graphics database 580 to determine whether a vector graphics representation is available for a landmark or intersection in view, given the current geographical view from the vehicle. The geographical view may be a geographical section calculated as a segment of a circle given by an angle of about 1-180 degrees (e.g. 90 °) and a radius of about 1-20 km (e.g., 10 km). The geographical section may approximately correspond to the human visual angle at the horizon.

The perspective calculation logic 540 may calculate a perspective view of the three-dimensional object represented by the vector graphics representation based on the position and driving direction of the vehicle. This perspective calculation logic 540 may apply mathematical transformations to the vector graphics representation to apply rotations, translations, scaling, or other perspective adjustments to the vector graphics representation for display. Thus, for example, as the landmark approaches, the perspective calculation logic 540 may increase the size and/or vary the viewing angle at which the representation is rendered to produce the view of the point of interest. The perspective calculation logic 540 may include software, firmware, or analog or digital circuitry. The circuitry may be contained in a microprocessor, microcontroller, an application specific integrated circuit (ASIC), custom circuit, or other semiconductor circuit.

The vector graphics representation and/or bitmaps for display may be sampled and mixed (e.g., combined into an image) by the display control logic 550. The display control logic 550 may render the display layers 401, 410, 420, 430, 440, 450, and 460 on the display 560. Additional, different, or fewer layers may be used. The display control logic 550 may be implemented with a graphics controller or processor implemented in software, firmware, or analog or digital circuitry. The circuitry may be contained in a microprocessor, microcontroller, an application specific integrated circuit (ASIC), custom circuit, or other semiconductor circuit.

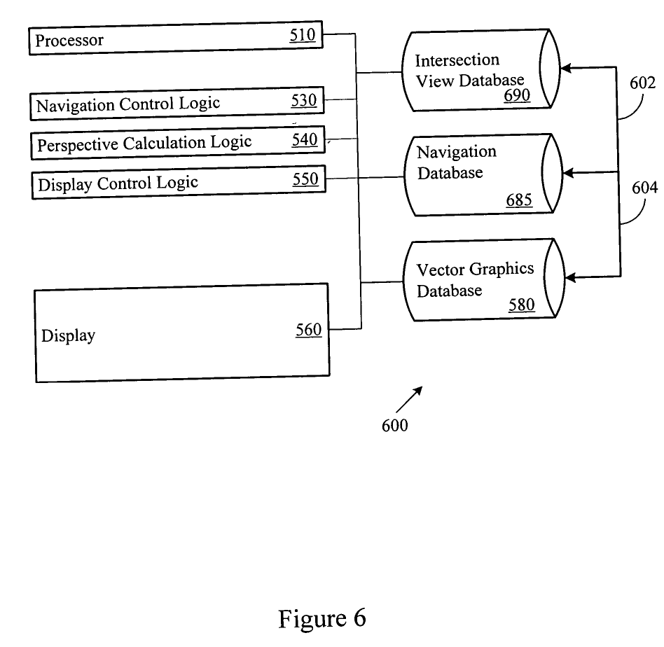

FIG. 6 illustrates databases 600 that may interfaced to the navigation system 500. The databases may include a vector graphics database 580 which stores two- and/or three-dimensional vector graphics representations of landmarks, textures of vector graphics, and coordinates of points (which may be grouped into mesh models or other graphical constructs); a navigation database 685 providing information about the location of the vehicle; and an intersection view database 690. The intersection view database 690 may include bitmap representations of the intersection views, the road geometry, or other features such as the skyline, signposts, street names, or other information. The databases 580, 685, and 690 may be linked to one another through database references 602 and 604. The database references may include pointers, database fields with reference data to external databases, or may be implemented in other ways. For example, a database reference from the intersection view database 690 to the vector graphics database 580 may specify a vector graphics representation for the intersection represented by a bitmap in the intersection view database 690.

The processor 510 may determine (e.g., using the navigation control logic 530) the position and speed of the vehicle based on the data provided by the navigation database 685. When the vehicle approaches an intersection, the processor 510 may reference the intersection view database 690 and retrieve the intersection view (e.g., as one or more bitmaps). The processor 510 may also reference the vector graphics database 680 directly, or may follow a database reference in the intersection view database 690, to retrieve a vector graphics representation of the intersection. The processor 510 may reference the vector graphics database 580 when directed by the navigation control logic 530 and/or navigation database 685, for example in response to a message from the navigation control logic 530 that the vehicle is approaching an intersection.

The processor 510 may retrieve the vector graphics representation for a landmark or an intersection from the vector graphics database 580. The perspective calculation logic 540 may calculate a perspective two- or three-dimensional view of the vector graphics representation. The perspective may be based on the vehicle speed and position information, the driving direction, the data from the navigation database 685 and/or the intersection view database 690.

The display control logic 550 (e.g., a graphics processor, graphics controller, or other display logic) may combine multiple display layers to obtain a composite navigation image 400. The display layers may include synthesized bitmap representations or vector graphics representations of the sky, the skyline, and the road geometry, and signposts and may be combined with display layers showing one or more landmarks in the background or foreground. The composite navigation image, including a three-dimensional perspective view of intersections and landmarks, may be displayed by the display device 560.

The processing described above may be implemented with a program stored in a signal bearing medium, a computer readable medium such as a memory, programmed within a device such as one or more integrated circuits, or processed by a controller or a computer. The program may reside in a memory resident to or interfaced to the processor 510, a communication interface, or any other type of memory interfaced to or resident with to the navigation system 500. The memory may include an ordered listing of executable instructions for implementing the processing described above. One or more of the processing acts may be implemented through digital circuitry, through source code, through analog circuitry, or through an analog electrical, audio, or video signal. The program may be embodied in any computer-readable or signal-bearing medium, for use by, or in connection with an instruction executable system, apparatus, or device. Such a system may include a computer-based system or other system that may selectively fetch and execute program instructions.

A “computer-readable medium,” “machine-readable medium,” “propagated-signal” medium, and/or “signal-bearing medium” may include any medium that contains, stores, communicates, propagates, or transports programs for use by or in connection with an instruction executing system, apparatus, or device. The machine-readable medium may be an electronic, magnetic, optical, electromagnetic, infrared, or semiconductor system, apparatus, device, or propagation medium. A non-exhaustive list of examples of a machine-readable medium includes: a portable magnetic or optical disk, a volatile memory such as a Random Access Memory “RAM” (electronic), a Read-Only Memory “ROM” (electronic), an Erasable Programmable Read-Only Memory (EPROM or Flash memory) (electronic), or an optical fiber (optical).

While various embodiments of the invention have been described, it will be apparent to those of ordinary skill in the art that many more embodiments and implementations are possible within the scope of the invention. Accordingly, the invention is not to be restricted except in light of the attached claims and their equivalents.

We claim:

1. A method for vehicle navigation, the method comprising:
determining a vehicle location;
determining a point-of-interest based on the vehicle location;
retrieving a resolution independent representation of the point-of-interest; and
generating a view of the point of interest from the resolution independent representation; and
displaying the view.

2. The method of claim 1, where:
retrieving comprises retrieving a three-dimensional resolution independent representation of the point of interest; and
where generating comprises generating a three-dimensional view from the three-dimensional resolution independent representation of the point of interest.

3. The method of claim 1, where the point of interest is an intersection.

4. The method of claim 1, where the point of interest is a landmark.

5. The method of claim 1, further comprising:
scaling the representation based on a distance from the point of interest.

6. A navigation system comprising:
a location system which determines a vehicle location;
a graphics database comprising a resolution independent representation of a point of interest; and
a processor coupled to the location system and the graphics database, the processor operable to determine when the point of interest is in view based on the vehicle location and responsively generate a view of the point of interest from the resolution independent representation.

7. The navigation system of claim 6, where the view comprises multiple layers.

8. The navigation system of claim 7, where the multiple layers comprise a first layer comprising the view of the point of interest, and a second layer comprising a bitmap image.

9. The navigation system of claim 6, where the processor is further operable to scale the representation without distortion based on a distance between the vehicle location and the point of interest.

10. The navigation system of claim 6, where the view is a three-dimensional perspective view.
